(19) United States
(12) Patent Application Publication
(10) Pub. No.: US 2005/0073166 A1
(43) Pub. Date: Apr. 7, 2005

(54) HYBRID MATERIAL BODY MOUNT FOR AUTOMOTIVE VEHICLES

(75) Inventor: David Snyder, Canton, MI (US)

Correspondence Address: MILLER LAW GROUP, PLLC;AND FORD GLOBAL TECHNOLOGIES, INC., 25 STEVENS AVENUE, WEST LAWN, PA, 19609, US

(73) Assignee: FORD GLOBAL TECHNOLOGIES, LLC, Dearborn, MI (US)

(21) Appl. No.: 10/605,506

(22) Filed: Oct. 3, 2003

(51) Int. Cl. B62D 27/04

(52) U.S. Cl. 296/35.1

(57) ABSTRACT

A hybrid body mount assembly is provided to mount automotive parts to a vehicle chassis. The body mount assembly is fabricated in a two-piece configuration with disparate elastomeric materials used for the upper and lower members. The hybrid material configuration both enhances noise transmission reduction and minimizes vehicle vibration. The upper body mount member is formed from micro cellular urethane to minimize noise transmission through the body mount assembly, while the lower mount member is fabricated from butyl rubber to minimize the transmission of vehicle vibrations. The hybrid material assembly achieves a 50% increase in damping without detrimentally affecting the transmission of noise.

### BACKGROUND OF INVENTION

1. Field of the Invention

This invention relates to the mounting of automotive body parts to a vehicle frame, and, more particularly, to a body mount assembly formed from two materials to provide maximum damping and minimum noise transmission.

2. Background of the Invention

Conventional body mount assemblies are formed in a two-piece configuration with the same elastomeric material in each piece. The body mount assembly is used to attach automotive body parts to a chassis frame so that the two metal components do not directly contact one another, as a direct contact would provide a high degree of noise transmission from one component to another, as well as a direct transmission of vibration and other mechanical actions. The two-piece body mount assembly utilizes a first elastomeric member engaged with the chassis frame and a second elastomeric member that is engaged with the automotive part to be mounted on the chassis. The two elastomeric members are then clamped together by a fastener that passes through an opening in the center of the elastomeric members. Since both the chassis and the automotive part are insulated from one another and from the fastener by the two elastomeric members, the transmission of noise and vibrations from the chassis to the automotive part is minimized.

Both of the elastomeric members of the two-piece body mount assembly known in the prior art are formed from similar materials. Such materials include natural rubber, butyl rubber and micro cellular urethane. Each of these materials provides different vibration and noise transmission capabilities, even within the variations with respect to a particular material. A material that increases damping to reduce vehicle vibrations results in an increase in noise transmission through the body mount assembly. Conversely, the choice of a material to decrease the amount of noise transmitted through the body mount assembly would decrease damping and, therefore, result in an increase in the transmission of mechanical vibrations through the body mount assembly.

U.S. Pat. No. 6,113,084, granted to James Norkus on Sep. 5, 2000, discloses the use of micro cellular urethane as the preferred micro-cellular polymeric material that is used in the disclosed jounce bumper. U.S. Pat. No. 5,799,930, issued to Mark Willet on Sep. 1, 1998, is directed to a two-piece body mount assembly positioned above and below the vehicle frame. Both elastomeric members comprising the two-piece body mount assembly are fabricated from the same material, a micro-cellular polyurethane.

U.S. Pat. No. 5,467,970, granted to John Ratu on Nov. 21, 1995, is directed to the employment of an integral jounce bumper including a first outer part that is fabricated from micro-cellular urethane which receives within a central pocket a second inner part that is fabricated from a harder rubber material, thus providing a two stage bumper assembly. U.S. Pat. No. 6,364,296 issued to Neil Cummings, et al. on Apr. 2, 2002, discloses a shear mount formed from a micro-cellular polyurethane isolator that is fabricated integrally with an insert fabricated from polymeric materials or reinforced resinous materials.

U.S. Pat. No. 6,471,179 issued to Shahram Tousi on Oct. 29, 2002, is directed to a micro-cellular insulator with three different cross-sections. A disc-shaped isolator is employed with a rubber bushing. U.S. Pat. No. 5,040,764, granted to Neil Dubois on Aug. 20, 1991, employs polyurethane shock-absorbing rings on opposite sides of a steel ring. The center steel ring acts as an intermediate mass that to increase the vibration isolation capabilities of the assembly at higher frequencies. The polyurethane foam rings absorb energy in the low frequency vibration absorbing assembly. U.S. Pat. No. 6,419,215 issued to David Johnson on Jul. 16, 2002, and is directed to a rubber shock absorber in which is utilized a two material bushing in which the two elastomeric materials are disposed within the sleeve of the shock absorber. The two materials have a different modulus so that one elastomeric material will absorb low frequency vibrations while the other elastomeric material will absorb a high frequency vibration.

None of the known prior art references teach a body mount assembly in which two different elastomeric materials are used on the upper and lower members, respectively, to provide selective tunability for isolation and damping characteristics. Accordingly, it would be desirable to provide a hybrid material body mount assembly for in mounting automotive parts to a vehicle chassis frame.

### SUMMARY OF INVENTION

It is an object of this invention to overcome the aforementioned disadvantages of the known prior art by providing a hybrid material body mount assembly for mounting automotive parts to the chassis frame.

It is another object of this invention to provide a body mount assembly that is tunable to enhance the operation to reduce both noise transmission and vehicle vibration.

It is a feature of this invention that a body mount assembly is tunable to enhance operation in reducing vehicle vibrations and noise transmission by selecting disparate materials for the upper and lower members of the assembly.

It is an advantage of this invention that the hybrid material body mount assembly will reduce vehicle vibrations without detrimentally increasing the transmission of noise through the assembly.

It is another advantage of this invention that the noise reduction and vibration transmission characteristics of a body mount assembly can be selectively varied by changing the materials from which one or another of the assembly members is fabricated.

It is another feature of this invention that the compound and rate flexibility maximizes isolation and increases damping characteristics for an automotive vehicle.

It is still another advantage of this invention that the hybrid material body mount assembly results in superior road NVH reductions.

It is still another feature of this invention that the hybrid material body mount assembly can directly replace conventional two-piece body mounts in the assembly of automotive vehicles.

It is yet another feature of this invention that the lower member of a two-piece body mount assembly can be fabricated from butyl rubber while the upper member is formed from micro-cellular urethane.

It is yet another advantage of this invention that the butyl rubber lower member minimizes vehicle vibration transmission, while the micro cellular urethane upper member has a superior noise transmission characteristics.

It is a further advantage that the hybrid material body mount assembly achieved 50% more damping than an industry standard body mount assembly formed from only micro cellular urethane.

It is still another object of this invention to provide a body mount assembly for use in attaching automotive parts to a vehicle chassis that is durable in construction, inexpensive of manufacture, carefree of maintenance, facile in assemblage, and simple and effective in use.

These and other objects, features and advantages are accomplished according to the instant invention by providing a hybrid body mount assembly for use in mounting automotive parts to a vehicle chassis. The body mount assembly is fabricated in a two-piece configuration with disparate elastomeric materials used for the upper and lower members. The hybrid material configuration both enhances noise transmission reduction and minimizes vehicle vibration. The upper body mount member is formed from micro cellular urethane to minimize noise transmission through the body mount assembly, while the lower mount member is fabricated from butyl rubber to minimize the transmission of vehicle vibrations. The hybrid material assembly achieves a 50% increase in damping without detrimentally affecting the transmission of noise.

### BRIEF DESCRIPTION OF DRAWINGS

The advantages of this invention will become apparent upon consideration of the following detailed disclosure of the invention, especially when taken in conjunction with the accompanying drawings wherein:

FIG. 1 is a perspective view of a representative vehicle chassis frame having mounts for the attachment of automotive body components thereto;

FIG. 2 is an enlarged perspective view of a vehicle chassis body mount to which an automotive part is being attached by a body mount assembly incorporating the principles of the instant invention;

FIG. 3 is a perspective view of the hybrid material body mount assembly incorporating the principles of the instant invention;

FIG. 4 is a cross sectional view of the hybrid body mount assembly taken through the center of the body mount depicted in FIG. 3; and

FIG. 5 is a graph representing the enhanced performance of a hybrid body mount assembly fabricated according to the principles of the instant invention, as compared to conventional body mount assemblies.

### DETAILED DESCRIPTION

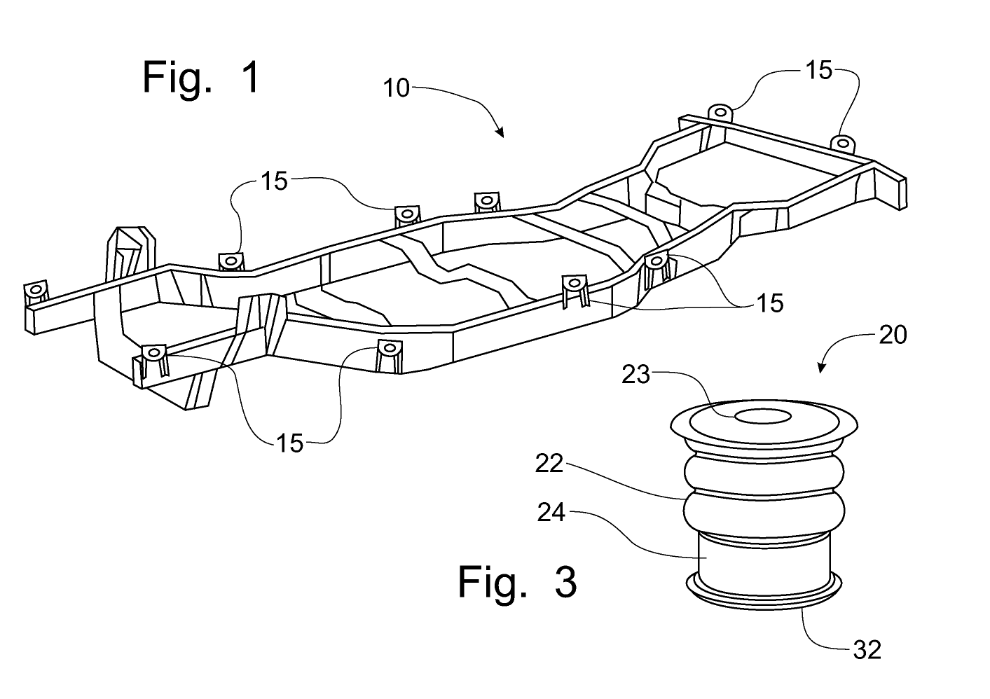

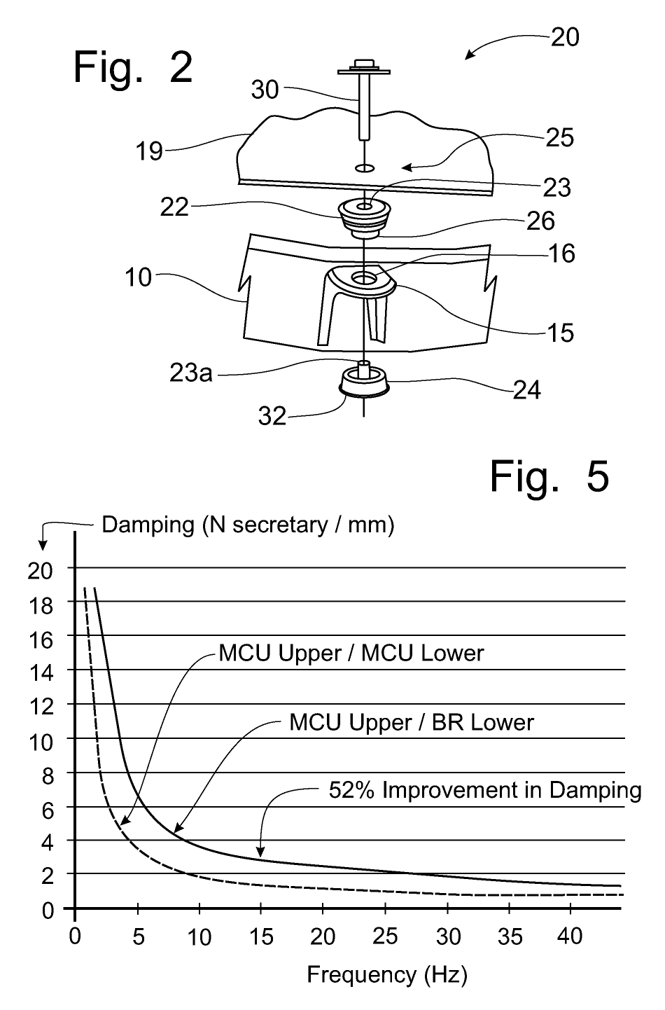

Referring to FIGS. 1 and 2, a vehicle chassis containing mounting brackets to which respective automotive parts and components are to be attached to the chassis 10. The chassis 10 is representative of automotive chassis frames to which appropriate automotive body parts are to be attached by connecting the body part or component to a chassis mounting bracket 15. As one of ordinary skill in the art will recognize, a vehicular chassis frame 10 will be manufactured with a plurality of mounting brackets 15 to secure the exterior sheet metal and other components 19 to the chassis frame 10.

Instead of directly bolting the automotive component 19 to the chassis frame by a bolt fastening the component 19 to the corresponding mounting bracket 15, a substantial reduction of noise transmission from the road and other external sources through the chassis 10 and mechanically transferred to the automotive component 19 can be accomplished by insulating the metal parts 10, 19 with an elastomeric material. In addition to a reduction in noise transmission, vehicle vibrations transmitted through the connecting joint is also significantly diminished.

Over the years, this elastomeric joint has evolved into a two-piece body mount assembly in which an upper member is connected to the vehicle body component 19 and a lower member is connected to the chassis frame mounting bracket with a fastener being inserted through a central opening through the upper and lower members. The fastener clamps the two elastomeric members together to provide a resilient mounting for the respective body component. Standard body mount assemblies will use the same elastomeric material for both the upper and lower member, the material being selected from the group comprising, butyl rubber, natural rubber and micro cellular urethane, among others.

Referring now to FIGS. 3 and 4, the hybrid material body mount assembly 20 can best be seen. The body mount assembly 20 is formed with an upper member 22, fabricated from micro cellular urethane to provide a relatively soft elastomeric material that will be effective to minimize the transmission of noise through the assembly, and a lower member 24 fabricated from an elastomeric material, such as butyl rubber, that has a much denser and harder consistency than the micro cellular urethane. Each of the upper and lower elastomeric members 22, 24 are formed with a central opening 23, 23a extending therethrough to form a donut-like configuration.

The mounting flange 25 for the automotive body part 19 to be mounted to the chassis 10 is preferably formed to have a shaft-like portion 26 that is insertable through the central opening 23 of the upper member 22 and extends through the central opening 23a in the lower member 24. The mounting bracket 15 of the chassis frame 10 is also formed with an opening 16 through which the upper body mount member 22 extends, along with the shaft portion 26 of the mounting flange 25. The elastomeric material of the upper member 22 prevents direct contact between the mounting flange 25 of the body component and the mounting bracket 15 of the frame 10. The shape of the upper member 22, as is best seen in FIG. 4, is such that the upper member 22 lies on top of the mounting bracket 15 to separate the mounting flange 25 from the mounting bracket 15.

The lower member 24, made preferably from butyl rubber, engages the lower side of the mounting bracket 15 to dampen the vibrations transmitted thereto from the chassis frame 10. A through bolt 30 is positioned through the central openings 23, 23a and is threadably engaged with a retainer 32 that has a circumferential seat 33 that receives the lower member 24 and forces the lower member 24 upwardly against the mounting bracket 15. The tightening of the through bolt 30 into the retainer 32 draws the upper member 22 toward the lower member 24 and clamps the upper member 22 against the lower member 24.

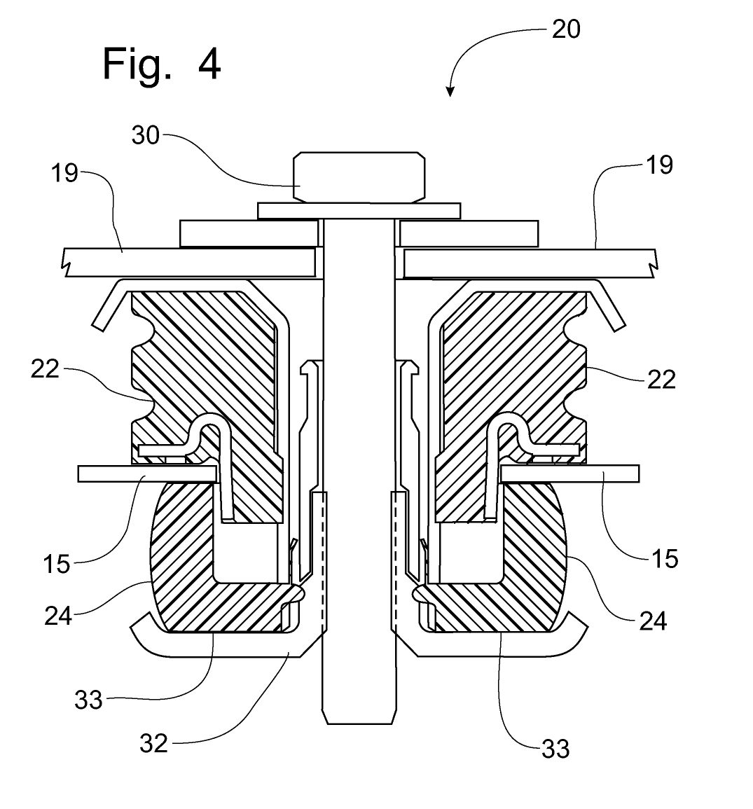

As a result, the denser butyl rubber lower member 24 provides a greater amount of damping to reduce the transfer of vehicular vibrations and mechanical noise through the elastomeric joint. The micro cellular urethane in the upper member 22 was chosen because of the superior transmissibility characteristics to minimize noise transfer. As an assembly 20 interconnecting the mounting flange 25 and the mounting bracket 15, the hybrid material assembly 20 achieved a 50% more damping than a standard body mount assembly fabricated with micro cellular urethane upper and lower members 22, 24, as is reflected in the graph of FIG. 5, while reducing interior noise levels.

Once assembled, the upper member 22 and the lower member 24 isolate the mounting bracket 15 from direct contact with any other metallic part or component, including the mounting flange 25, the retainer 32 and the through bolt 30. The hybrid material in the body mount assembly 20 cooperates to produce surprising results in the reduction of vibration and noise transmissions.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

1. A body mount assembly for mounting a mounting flange of a first component to a mounting bracket of a second component, comprising:
an upper member fabricated from a first elastomeric material and being positioned between the mounting flange and the mounting bracket;
a lower member fabricated from a second elastomeric material and being operable to engage said mounting bracket in an opposing relationship with respect to the upper member, said lower member being operable to isolate said mounting bracket from said mounting flange.

2. The body mount assembly of claim 1 wherein said upper member is fabricated from micro cellular urethane.

3. The body mount assembly of claim 2 wherein said lower member is fabricated from butyl rubber.

4. The body mount assembly of claim 2 wherein said lower member is fabricated from natural rubber.

5. The body mount assembly of claim 3 wherein said upper member and said lower member are clamped together by a fastener passing through a central opening formed in each of said upper and lower members.

6. The body mount assembly of claim 5 wherein said lower member is positioned between said mounting bracket and a retainer member coupled to said fastener.

7. In an automotive vehicle having a chassis frame formed with mounting brackets, and a plurality of body components formed with mounting flanges corresponding to said mounting brackets to permit attachment of said body components to said chassis frame, an improved body mount assembly interconnecting corresponding said mounting bracket and said mounting flange comprising:
an upper member fabricated from a first elastomeric material and being positioned between the mounting flange and the mounting bracket;
a lower member fabricated from a second elastomeric material and being operable to engage said mounting bracket in an opposing relationship with respect to the upper member, said lower member being operable to isolate said mounting bracket from said mounting flange.

8. The automotive vehicle of claim 7 wherein said upper member and said lower member are clamped together by a fastener passing through a central opening formed in each of said upper and lower members.

9. The automotive vehicle of claim 8 wherein said lower member is positioned between said mounting bracket and a retainer member coupled to said fastener.

10. The automotive vehicle of claim 9 wherein said upper member is fabricated from micro cellular urethane.

11. The automotive vehicle of claim 10 wherein said lower member is fabricated from butyl rubber.

12. In a body mount assembly for joining an automotive body component to a chassis frame having a mounting bracket formed thereon for connection to said body component via a fastener, said body mount assembly including an upper elastomeric member and a lower elastomeric member disposed on opposing sides of said mounting bracket to isolate said body component from said mounting bracket, the improvement comprising:
said upper and lower members being fabricated from disparate elastomeric materials.

13. The body mount assembly of claim 12 wherein one of said upper and lower members is fabricated from a soft elastomeric material to minimize noise transfer from said mounting bracket to said body component, the other of said upper and lower members being fabricated from a harder elastomeric material to minimize the transmission of vibrations from said chassis frame through said mounting bracket to said body component.

14. The body mount assembly of claim 13 wherein said upper member is positioned between said body component and said mounting bracket and said lower member is positioned on the opposing side of said mounting racket from said upper member and is positioned between said mounting bracket and a retainer member coupled with said fastener.

15. The body mount assembly of claim 14 wherein said fastener passes through an opening formed in the center of said upper and lower members to engage said retainer member and clamp said upper and lower members against said mounting bracket.

16. The body mount assembly of claim 15 wherein said upper member is fabricated from micro cellular urethane.

17. The body mount assembly of claim 16 wherein said lower member is fabricated from butyl rubber.

18. The body mount assembly of claim 17 wherein said lower member is formed of natural rubber.
